(19) United States
(12) Patent Application Publication
(10) Pub. No.: US 2026/0274485 A1
(43) Pub. Date: Sep. 17, 2026

(54) PACKAGING SYSTEM AND METHODS FOR DETECTING AND REMOVING MALFORMED CARTONS

(71) Applicant: R.A Jones & Co., Covington, KY (US)

(72) Inventors: Stephen C. Armstrong, Independence, KY (US); Dustin A. Foree, California, KY (US); David P. Hizer, Aurora, IN (US); Ethan I. Sketch, Fort Thomas, KY (US)

(21) Appl. No.: 19/077,662

(22) Filed: Mar. 12, 2025

(51) Int. Cl. B65B 57/04; B07C 5/36; B65B 43/44; B65B 43/52

(52) U.S. Cl. CPC B65B 57/04; B07C 5/363; B65B 43/44; B65B 43/52

(57) ABSTRACT

A cartoning system and method of operating same to package products in cartons is disclosed. The method includes providing the cartoning system including a carton magazine including a plurality of carton blanks, a carton feeder, a carton conveyor, a product conveyor, a product inserter, a carton detection system, and a carton reject system. Operating the carton feeder to transfer carton blanks to the carton conveyor and conveying each carton along the carton conveyor in a carton feed direction. The method includes conveying product along the product conveyor in a product feed direction, detecting an opened configuration of each carton with the carton detection system, and loading product into each carton that is detected to be in the opened configuration. The method includes detecting a malformed carton with the carton detection system, operating the carton conveyor to continuously convey cartons in the carton feed direction without interruption upon detection of one or more malformed cartons, bypassing the malformed carton by not loading product into the malformed carton, and operating the carton reject system to remove the malformed carton from the carton conveyor. The carton reject system operates independently of the carton feeder to remove the malformed carton.

### TECHNICAL FIELD

This invention relates generally to a cartoning or packaging system and, more particularly, to an apparatus and method for detecting and removing malformed cartons from the cartoning system.

### BACKGROUND

In a typical cartoning system, flat carton blanks are fed from a carton magazine to a forming station, where each carton blank is erected into a three-dimensional carton. The erected cartons are then conveyed to a product loading station, where they are loaded with product, such as food items, pharmaceuticals, or other consumer goods. Each filled carton may then be sealed before being further prepared and processed for shipment.

One challenge in cartoning systems arises when the forming station produces a malformed carton. Such malformations may include incomplete folds or structural misalignments, which may prevent the carton from properly advancing through the filling and sealing stages. For example, the forming station may produce a partially erected carton that is unable to be filled with product at the downstream loading station. When this occurs, the entire cartoning system may need to be halted, requiring manual intervention to locate and remove the malformed carton.

Furthermore, any product intended for the malformed carton, or product that may have attempted to be placed in the malformed carton, often must be removed from the cartoning system. The cartoning system typically cannot resume operations until the malformed carton and any affected product are removed from the cartoning line, resulting in substantial downtime and operational inefficiency.

Accordingly, there is a need for improvements in cartoning systems, and specifically in the ability to detect and automatically remove malformed or defective cartons from a cartoning system without requiring a shutdown of the cartoning system for manual intervention.

### SUMMARY

According to one embodiment of the present invention, a method of packaging product in cartons is disclosed. The method includes providing a cartoning system that includes a carton magazine including a plurality of carton blanks, a carton feeder, a carton conveyor, a product conveyor, a product inserter, a carton detection system, and a carton reject system. The method includes operating the carton feeder to transfer carton blanks to the carton conveyor, conveying each carton along the carton conveyor in a carton feed direction, and conveying product along the product conveyor in a product feed direction. The method further includes detecting an opened configuration of each carton with the carton detection system and loading product into each carton that is detected to be in the opened configuration. The method also includes detecting a malformed carton with the carton detection system, operating the carton conveyor to continuously convey cartons in the carton feed direction without interruption upon detection of one or more malformed cartons, and operating the carton reject system to remove the malformed carton from the carton conveyor.

According to one aspect of the present invention, each malformed carton may be removed from the carton conveyor without additional processing of the malformed carton prior to removal. In another aspect, each malformed carton may be removed from the carton conveyor in the malformed configuration. In yet another aspect, the carton reject system may contactlessly remove each malformed carton from the carton conveyor. In that regard, the carton reject system may include a blow-off device configured to selectively discharge a controlled volume of gas. The method may further include operating the blow-off device to release the controlled volume of gas aimed at the malformed carton to remove the malformed carton from the carton conveyor.

According to another aspect of the present invention, the carton reject system may be located downstream of the product inserter in the cartoning system. The method may further include bypassing the malformed carton by not loading product into the malformed carton. Alternatively, the carton reject system may be located upstream of the product inserter in the cartoning system. In yet another aspect, the method may include operating the product conveyor to continuously convey product in the product feed direction without interruption upon detection of one or more malformed cartons.

According to one aspect of the present invention, the carton detection system may include at least one sensor that is configured to detect a panel or a flap of each carton. For each carton, if a correct orientation of the panel or the flap of the carton is detected, confirming the opened configuration of the carton, or if an incorrect orientation of the panel or the flap of the carton is detected, confirming the carton to be the malformed carton for removal. In yet another aspect, the at least one sensor of the carton detection system may include a first sensor configured to detect an orientation of a panel of each carton, a second sensor configured to detect an orientation of a first end flap at a first end of each carton, and a third sensor configured to detect an orientation of a second end flap at an opposite second end of each carton. An incorrect orientation detected by any one of the first sensor, the second sensor, or the third sensor results in confirming the carton to be the malformed carton for removal.

In yet another aspect of the present invention, the carton feeder may be configured to reconfigure each carton blank from a collapsed configuration to the opened configuration to define each carton that is configured to receive product.

According to another embodiment of the present invention, a cartoning system for packaging product in cartons is disclosed. The cartoning system includes a carton magazine including a plurality of carton blanks, a carton feeder that is configured to transfer carton blanks to a carton conveyor, and a carton detection system that is configured to detect an opened configuration of each carton or a malformed carton. The carton conveyor is configured to continuously convey cartons in the carton feed direction without interruption upon detection of one or more malformed cartons by the carton detection system. The cartoning system further includes a carton reject system that is configured to remove each malformed carton from the carton conveyor and a computer operatively coupled to the cartoning system. The computer is configured to operate the cartoning system as follows: operate the conveyor to convey each carton along the carton conveyor in a carton feed direction and operate the carton detection system to detect for the opened configuration of each carton or if the carton is malformed. If the carton is detected to be malformed, operate the carton reject system to remove the malformed carton from the carton conveyor. The carton reject system may operate independently of the carton feeder to remove the malformed carton.

According to one aspect of the present invention, the malformed carton may be removed from the carton conveyor without being loaded with product. In another aspect, the malformed carton may be removed from the carton conveyor by the carton rejection system at a location that is downstream of a product inserter of the cartoning system. Alternatively, the carton reject system may be located upstream of the product inserter in the cartoning system. In another aspect, the malformed carton may be removed from the carton conveyor without additional processing of the malformed carton prior to removal. For instance, the malformed carton may be removed from the carton conveyor in the malformed configuration.

According to another aspect of the present invention, the carton reject system may be configured to contactlessly remove the malformed carton from the carton conveyor. In one aspect, the carton reject system may include a blow-off device that is configured to selectively discharge a controlled volume of gas aimed at the malformed carton to remove the malformed carton from the carton conveyor.

According to one aspect of the present invention, the carton feeder may be configured to reconfigure each carton blank from a collapsed configuration to the opened configuration to define each carton that is configured to receive product.

According to yet another aspect of the present invention, the carton detection system may include at least one sensor that is configured to detect a panel or a flap of each carton. The controller is configured to operate the cartoning system as follows: if a correct orientation of the panel or the flap of the carton is detected, confirming the opened configuration of the carton, or if an incorrect orientation of the panel or the flap of the carton is detected, confirming the carton to be the malformed carton for removal. In one aspect, the at least one sensor of the carton detection system may include a first sensor configured to detect an orientation of a panel of each carton, a second sensor configured to detect an orientation of a first end flap at a first end of each carton, and a third sensor configured to detect an orientation of a second end flap at an opposite second end of each carton. An incorrect orientation detected by any one of the first sensor, the second sensor, or the third sensor results in confirming the carton to be the malformed carton for removal.

Various additional features and advantages of the invention will become more apparent to those of ordinary skill in the art upon review of the following detailed description of one or more illustrative embodiments taken in conjunction with the accompanying drawings.

### BRIEF DESCRIPTION OF THE DRAWINGS

The accompanying drawings, which are incorporated in and constitute a part of this specification, illustrate one or more embodiments of the invention and, together with the general description given above and the detailed description given below, serve to explain the one or more embodiments of the invention.

FIG. 1 is a schematic view of an exemplary cartoning system including a malformed carton detection system and a carton reject system in accordance with one embodiment of the present invention.

FIG. 1A is a schematic view of an exemplary cartoning system including a malformed carton detection system and a carton reject system in accordance with another embodiment of the present invention.

FIG. 2 is a schematic view of an exemplary computing system configured to control the operation of the cartoning system of FIG. 1 according to embodiments of the present invention.

FIG. 3 is a side view illustrating operation of a gripping device of a carton feeder to erect and place a carton between lugs on a carton conveyor of the cartoning system of FIG. 1, the carton being illustrated in an opened configuration.

FIG. 4 is a view similar to FIG. 3, illustrating an undesirable malformed carton placed on the carton conveyor by the carton feeder.

FIG. 5 is a perspective view illustrating an arrangement of the sensors of the malformed carton detection system to detect flaps and panels of an exemplary carton in accordance with an embodiment of the present invention.

FIG. 6 is a side view of the carton of FIG. 5, further illustrating the parts of the carton that are configured to be detected by the sensors of the malformed carton detection system.

FIG. 7 is a schematic plan view of the cartoning system of FIG. 1, illustrating a malformed carton on the carton conveyor being detected by the malformed carton detection system.

FIG. 8 is a view similar to FIG. 7, illustrating further operation of the cartoning system upon detection of the malformed carton, including the continued loading of product into properly erected cartons.

FIG. 9 is a view similar to FIGS. 7 and 8, illustrating further operation of the cartoning system upon detection of the malformed carton.

FIG. 10 is a view similar to FIGS. 7-9, illustrating further operation of the cartoning system upon detection of the malformed carton, including bypassing the loading of product into the malformed carton.

FIGS. 11-13 are views similar to FIGS. 7-10, illustrating further operation of the cartoning system upon bypassing the loading of product into the malformed carton.

FIG. 14 is a view similar to FIGS. 7-13, illustrating the diversion of the product that was intended to be loaded into the malformed carton.

FIG. 15 is a view similar to FIGS. 7-14, illustrating the removal of the malformed carton from the carton conveyor by the carton reject system.

FIG. 16 is a view similar to FIGS. 7-15, illustrating further operation of the cartoning system after the malformed carton has been removed.

FIG. 17 is a flowchart illustrating a process for detecting and removing a malformed carton from the cartoning system of FIG. 1.

### DETAILED DESCRIPTION

Aspects of the present invention are directed to a cartoning system that forms, fills, and seals cartons for product packaging. The cartoning system may alternatively be referred to as a packaging system. In general, the cartoning system is configured to erect properly formed cartons from carton blanks received from a carton magazine, receive product from a product source, and transfer the received product into the erected cartons. Additionally, the cartoning system is configured to seal each carton to securely contain the product in the cartons for bulk packaging. In order for product to be placed in each carton, the carton must be properly erected and opened to receive the product. The carton must not be malformed or otherwise defective in a way that would prevent it from accepting the product.

As described in further detail below, the cartoning system according to embodiments of the present invention includes a carton detection system that identifies whether each carton is properly erected and opened to receive product. That way, product may either be loaded into the carton, or diverted if the carton is detected to be malformed. The carton detection system may include one or more sensors that are operational to verify specific parameters and/or a proper orientation of each carton to confirm that the carton is properly erected and opened to properly accept product. Additionally, the cartoning system according to embodiments of the present invention includes a carton reject system that is configured to automatically remove from the cartoning system any carton that is detected to be malformed or otherwise defective (referred to as a “malformed carton”) without requiring a shutdown of the cartoning system. Each malformed carton is removed without being filled with product, and any product intended for each malformed carton may be diverted for discard or reuse. Each of these operations are performed automatically without human intervention, and without stopping any operation of the cartoning system. These and other benefits of the present invention will be described in further detail below.

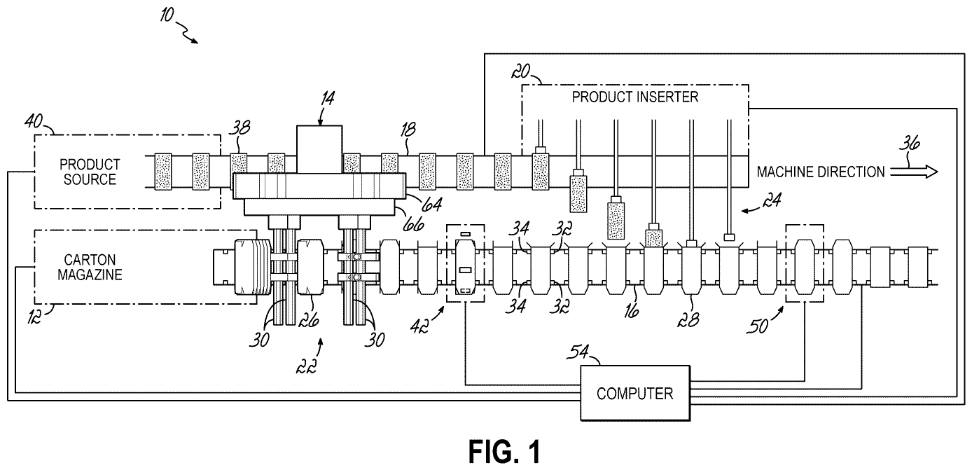

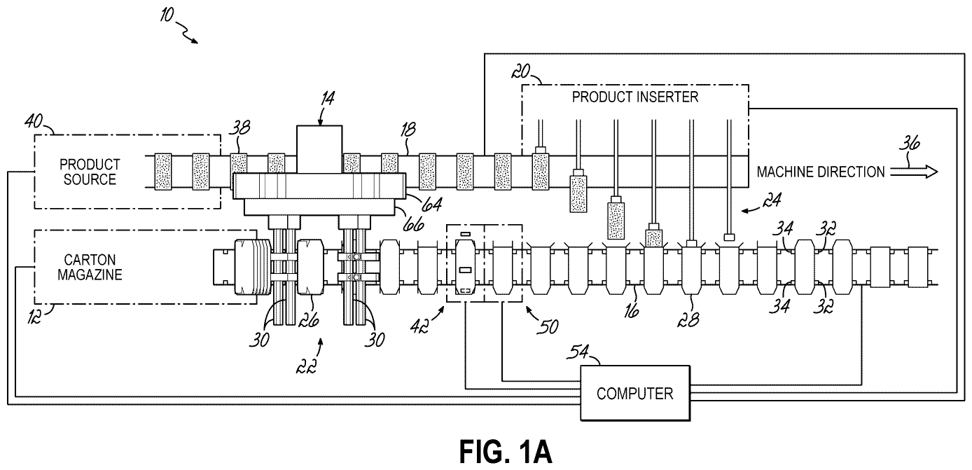

Referring now to the figures, FIG. 1 illustrates an exemplary cartoning system 10, which may be an end load cartoning system. However, while aspects of the present invention are shown and described in the context of one type of cartoning system 10, it will be understood that the same inventive aspects of the present invention may be implemented with different cartoning systems and packaging systems, broadly, without departing from the scope of the invention. The exemplary cartoning system 10 shown may form part of a larger packaging system that is configured to form, fill and seal one or more products into erected cartons for further processing and/or distribution. As will be understood by a person skilled in the art of packaging, cartoning systems include several interconnected stations that handle various packaging tasks, such as carton blank feeding, carton forming, carton loading, carton sealing, and discharging. The exemplary cartoning system 10 shown includes at least one carton magazine 12, a carton feeder 14, a carton conveyor 16, a product conveyor 18, and a product inserter 20. To that end, the cartoning system includes a carton feeding and forming station 22 and a product loading station 24, which may form part of a larger cartoning or packaging system.

With continued reference to FIG. 1, the carton magazine 12 is configured to store a number of flat cartons, or carton blanks 26, before they are fed into the cartoning system 10 for processing. In particular, the carton magazine 12 is configured to hold multiple carton blanks 26 in a stack, and is configured to supply carton blanks 26 to the carton feeder 14 as needed to ensure a continuous workflow. The carton feeder 14 retrieves carton blanks 26 from the carton magazine 12 and moves the carton blanks 26 to the carton conveyor 16. In the exemplary embodiment shown, the carton feeder 14 reconfigures each carton blank 26 from a collapsed configuration to an opened three-dimensional configuration that defines an erected carton 28 (i.e., carton) that is configured to receive product. To that end, the exemplary carton feeder 14 shown may be a rotary or orbital carton feeder equipped with multiple gripping devices 30 that are configured to pick each carton blank 26 from the carton magazine 12, break and open each carton blank 26 to the desired erected configuration, and then place each erected carton 28 onto the carton conveyor 16. In an alternative embodiment, the carton feeder 14 may retrieve carton blanks 26 from the carton magazine 12 and transfer the carton blanks 26 to the carton conveyor 16 or a carton former. In that regard, the carton feeder 14 may be separate from the carton former, which opens or forms each carton blank 26 into the desired erected configuration. The carton former may be a piece of equipment or one or more individuals responsible for opening or forming each carton blank 26 into the desired erected configuration to receive product, for example.

The carton conveyor 16 is configured to move or transport the cartons 28 received from the carton feeder 14 downstream for further processing. In that regard, each carton 28 is placed onto the carton conveyor 16 by the carton feeder 14, and in particular, between sets of conveyor lugs 32, 34 which serve to retain the carton 28 in its opened configuration on the carton conveyor 16. The conveyor lugs 32, 34 may be arranged in pairs on either side of the carton 28, for example. To that end, the pairs of conveyor lugs 32, 34 may be referred to as leading lugs 32 and trailing lugs 34, corresponding to a machine direction 36 of the carton conveyor 16 (i.e., a carton feed direction). The carton conveyor 16 is configured to convey the cartons 28 in a carton feed direction to the product loading station 24 where each carton 28 is to be filled with product, as will be described in further detail below. While not shown, the carton conveyor 16 may further convey each filled carton 28 to a downstream gluing and closing station, for example.

Operating generally alongside the carton conveyor 16 is the product conveyor 18, which may be a separate conveyor that transports product 38 in a product feed direction that corresponds to the machine direction 36. In particular, the product conveyor 18 is configured to convey product 38 from a product source 40 to the product inserter 20 at the product loading station 24 where the product 38 is inserted or loaded into respective cartons 28. As shown, the product conveyor 18 may operate generally in parallel with the carton conveyor 16 such that the product feed direction and the carton feed direction are in the same direction. As each product 38 reaches the product loading station 24, the product inserter 20 accurately places or loads each product 38 into a respective carton 28 on the carton conveyor 16. To accomplish this, the product inserter 20 may use one or more robotic arms, pushers, rams, or similar mechanisms that are configured to transfer, such as by pushing, the product 38 from the product conveyor 18 and into an open end of the respective carton 28 on the carton conveyor 16. To that end, a conveying surface of the product conveyor 18 and the carton conveyor 16 may be adjacent to one another, and level, to ensure a smooth transition of the product 38 from the product conveyor 18 and into the erected carton 28 on the carton conveyor 16.

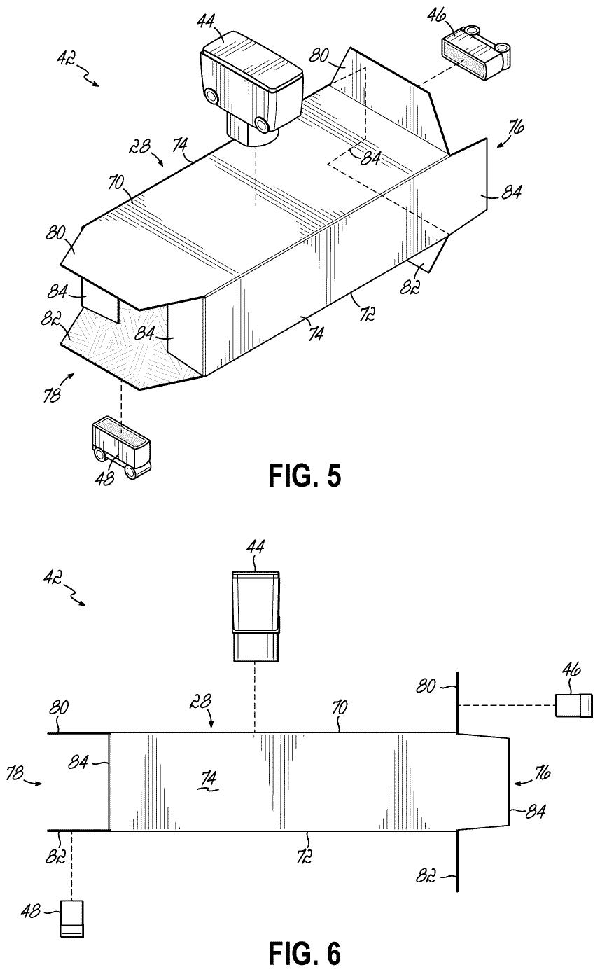

The cartoning system 10 further includes a carton detection system 42 that is configured to confirm or verify that each carton 28 placed on the carton conveyor 16 has been correctly erected by the carton feeder 14 (or separate carton former) into an opened configuration to receive product 38. The carton detection system 42 may include one or more sensors 44, 46, 48 (e.g., FIGS. 5 and 6) that are operational to verify specific parameters and/or the orientation of each carton 28 to confirm that the carton 28 is properly erected and opened to accept product 38, as will be described in further detail below. In the embodiment shown, the carton detection system 42 is located along the carton conveyor 16, downstream of the carton feeder 14 and upstream of the product inserter 20. The terms downstream and upstream are used with respect to the machine direction 36. That is, the carton detection system 42 is located downstream of the carton feeding and forming station 22 and upstream of the product loading station 24. The carton detection system 42 is positioned upstream of the product loading station 24 to identify malformed cartons before they reach the product loading station 24, ensuring that any malformed carton is not filled with product 38. To that end, the malformed cartons may be identified and tracked for downstream removal of each malformed carton from the carton conveyor 16 by a carton reject system 50.

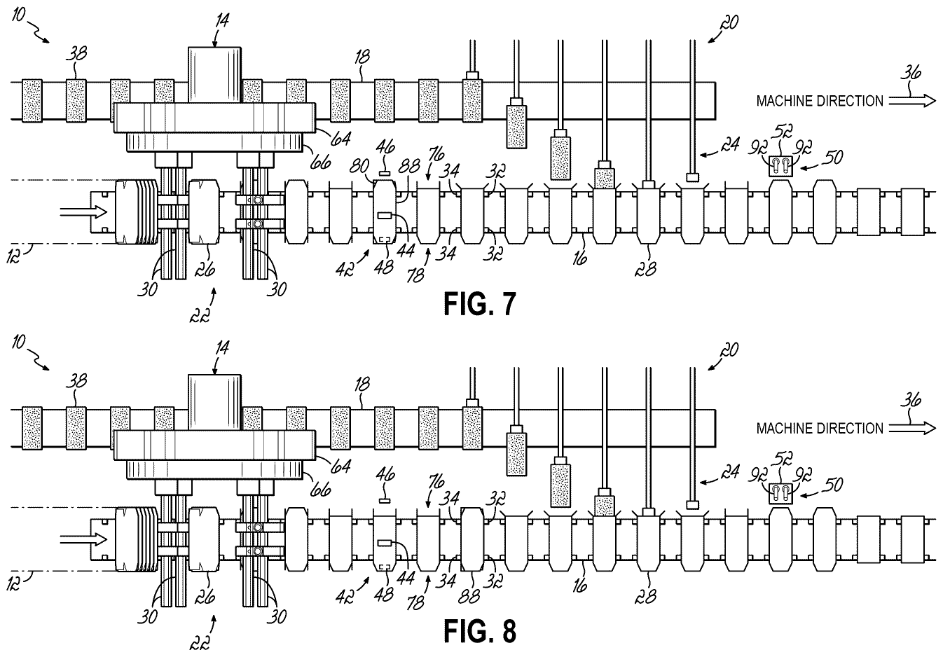

With continued reference to FIG. 1, the cartoning system 10 includes the carton reject system 50 that is configured to remove each malformed carton detected by the carton detection system 42 without requiring a shutdown of the cartoning system 10 or manual intervention to remove the malformed carton. Each malformed carton is removed from the carton conveyor 16 by the carton reject system 50 in the malformed configuration and without being filled with product 38. That is, the malformed carton is not attempted to be reworked once detected. Rather, the malformed carton is detected and subsequently removed without further processing to avoid any slowing or stoppage of the cartoning system 10. To that end, product 38 intended to be loaded into each malformed carton may be diverted for discard or reuse. In the embodiment shown, the carton reject system 50 includes a blow-off device 52 (e.g., FIG. 7) that is configured to contactlessly remove each malformed carton from the carton conveyor 16, as will be described in further detail below. However, in an alternative embodiment, the carton reject system 50 may instead include one or more robotic arms, pushers, rams, paddles, chains, or similar mechanisms that are configured to remove each malformed carton from the carton conveyor 16. In the embodiment shown, the carton reject system 50 is located along the carton conveyor 16, downstream of the product inserter 20 and the product loading station 24. However, the carton reject system 50 may alternatively be located upstream of the product inserter 20, as shown in FIG. 1A.

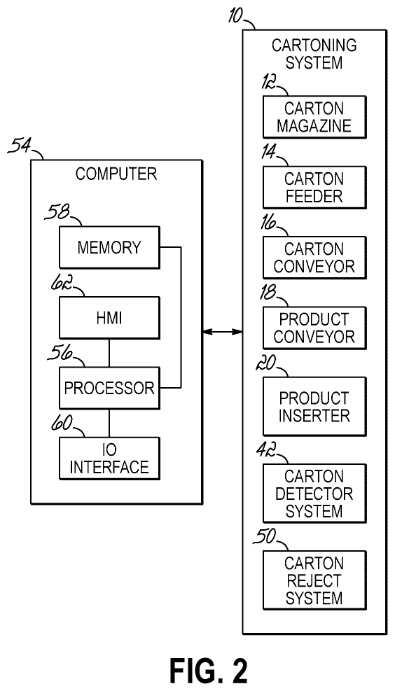

Turning now with reference to FIGS. 1 and 2, the cartoning system 10 may include one or more control panels where appropriate control equipment (i.e., one or more controllers) for components of the cartoning system 10 are located. While Human Machine Interfaces (HMI) may be located on specific equipment, the control panel(s) may be where one or more HMIs and programmable logic controllers (PLC) are located, for example. To this end, according to embodiments of the present invention, components of the cartoning system 10 are responsive to stored programs for commanding operation of those components. The programs may be computer-readable program instructions for carrying out operations in accordance with the embodiments of the present invention. The computer-readable programs may be assembly language, source code, or object code written in any combination of one or more programming languages, and may be implemented using one or more computing devices or systems 54 which may include a processor 56, a memory 58, an input/output (I/O) interface 60, and a Human Machine Interface (HMI) 62, for example.

Referring now to FIGS. 1, 3 and 4, operation of the carton feeder 14 will be described in additional detail. The exemplary carton feeder 14 is fully disclosed in at least U.S. Pat. Nos. 4,518,301 and 4,596,454, the contents of which are hereby incorporated herein by reference in their entireties. Therefore, the carton feeder 14 will only be briefly described herein. As shown, the carton feeder 14 includes a frame 64 that rotatably supports a wheel 66 for rotation. The wheel 66 rotatably supports multiple gripping devices 30 which are each rotatable relative to the wheel 66 of the carton feeder 14. In the embodiment shown, the wheel 66 supports four gripping devices 30. Each gripping device 30 is configured to engage a carton blank 26 to transfer and transform the carton blank 26 to an erected carton 28, and place the carton 28 on the carton conveyor 16.

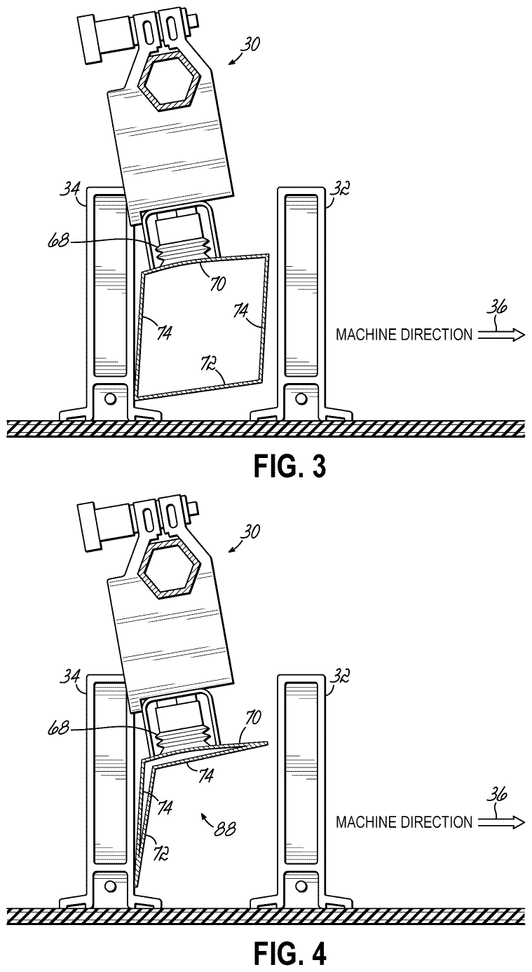

As shown in FIGS. 3 and 4, each gripping device 30 includes one or more suction cups 68 that are operable to selectively engage a carton blank 26 to pull the carton blank 26 against the gripping device 30 for transport. In particular, as the wheel 66 of the carton feeder 14 rotates, each gripping device 30 is rotated past the carton magazine 12. Each gripping device 30 is further rotated relative to the wheel 66 to bring the suction cups 68 into engagement with a respective carton blank 26 held by the carton magazine 12. With continued rotation of both the wheel 66 and the gripping device 30, the carton blank 26 held by the gripping device 30 follows a complex motion that partially opens the carton blank 26 (e.g., breaks the carton blank 26). The carton blank 26 is further moved to the carton conveyor 16 and positioned between a set of conveyor lugs 32, 34. A final movement by the gripping device 30 as the carton 28 is released against the conveyor lugs 32, 34 may fully open the carton 28 to the desired opened configuration, as generally shown in FIG. 3, where the carton 28 is ready to receive product 38. The carton 28 is then carried away from the carton feeder 14 by the carton conveyor 16 to the loading station 24, where the carton 28 may be filled with product 38.

Turning now with reference to FIGS. 5 and 6, the exemplary cartons 28 shown, when erected, are of rectangular cross-sectional configuration, including a top panel 70 and a bottom panel 72 connected by a pair of side panels 74, with the panels extending between opposite ends 76, 78 of the carton 28. In particular, the top panel 70 includes a top flap 80 at each end 76, 78 of the carton 28, the bottom panel 72 includes a bottom flap 82 at each end 76, 78 of the carton 28, and the pair of side panels 74 each include a side flap 84 at each end 76, 78 of the carton 28. When in the open position, the flaps 80, 82, 84 at least at one end 76 of the carton 28, which may be referred to as the loading end 76, remain apart, leaving the loading end 76 open. That way, product 38 may be loaded into the carton 28 through the loading end 76, as will be described in further detail below. When the carton 28 is positioned on the carton conveyor 16, the loading end 76 may be arranged to face the product inserter 20.

A malformed carton may occur in several ways at the carton forming station 14. For example, improper pick-up of a carton blank 26 by a gripping device 30 of the carton feeder 14 can result in misalignment of the carton blank 26 when placed on the carton conveyor 16, or weak or damaged score lines on the carton blank 26 may lead to a malformed carton. Carton blanks 26 typically have score lines that facilitate proper folding into the correct, opened shape; weak or damaged score lines may prevent proper opening of the carton blank 26. There are several categories of malformed cartons, such as collapsed cartons, misaligned cartons, partially opened cartons, unopened cartons, overfolded cartons, and crushed cartons, for example. One common type of malformed carton is the “L”-shaped malformed carton 88 shown in FIG. 4, which may fall within the unopened category of malformed cartons. This type of carton malformation occurs when the carton feeder 14 (or separate carton former) fails to adequately open the carton blank 26 before placing the carton blank 26 on the carton conveyor 16. As a result, the carton blank 26 bends over between the lugs 32, 34 in an unopened, L-shaped configuration, resulting in a malformed carton 88 that is unable to be loaded with product 38, as shown in FIG. 4.

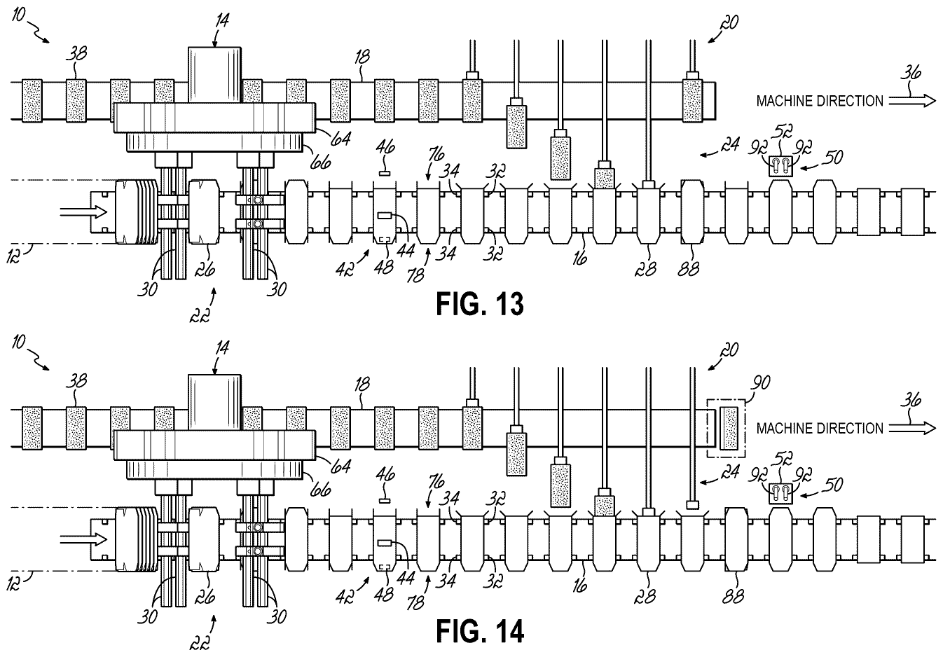

Referring now to FIGS. 7-16, operation of the cartoning system 10 to detect the opened configuration of each carton 28, or a malformed carton 88, with the carton detection system 42, and subsequent removal of each detected malformed carton 88 with the carton reject system 50, will now be described. As briefly described above, the carton feeder 14 operates continuously to transfer carton blanks 26 to the carton conveyor 16 to provide the cartoning system 10 with a continuous workflow. As shown in FIG. 7, a majority of the cartons 28 placed on the carton conveyor 16 by the carton feeder 14 are in a desired, opened configuration, to receive product 38. However, as shown, the carton feeder 14 has produced an L-shaped malformed carton 88.

Once placed on the carton conveyor 16, each carton 28 is confirmed to be in the opened configuration by the carton detection system 42. In that regard, the carton detection system 42 is downstream from the carton feeder 14 along the carton conveyor 16 such that each carton 28 placed onto the carton conveyor 16 passes through the carton detection system 42. The carton detection system 42 includes three sensors 44, 46, 48 that are configured to detect aspects of each carton 28 to confirm the carton 28 is in the opened configuration to receive product 38. Each sensor 44, 46, 48 may be one of a photoelectric sensor, a proximity sensor, a limit switch, an ultrasonic sensor, a vision sensor, or a laser sensor, for example. The sensors 44, 46, 48 may all be the same type of sensor, or a combination of different sensors. For instance, one sensor 44 may be a photoelectric sensor to confirm that a carton 28 is present in each space between sets of lugs 32, 34. The remaining two sensors 46, 48 may be either a proximity, a vision, or a laser sensor to confirm that the ends 76, 78 of the carton 28 are properly oriented and/or are fully open. Each sensor 44, 46, 48 may be supported from the frame of the carton conveyor 16, or other parts of the cartoning system 10, or one or more of the sensors 44, 46, 48 may be part of a standalone unit that may be positioned relative to the carton conveyor 16, for example.

With reference to FIGS. 5-7, the first sensor 44 may be suspended directly over the carton conveyor 16, such as a belt of the carton conveyor, to detect the presence and/or an orientation of each carton 28. For example, the first sensor 44 may be configured to detect for the presence of a carton 28, and in particular the top panel 70 of the carton 28, within each space between sets of lugs 32, 34 of the carton conveyor 16. Additionally or alternatively, the first sensor 44 may be configured to detect the orientation of the top panel 70 of each carton 28. For example, the first sensor 44 may be configured to detect a generally planar orientation of the top panel 70, which would indicate that the carton 28 is correctly oriented in an open configuration on the carton conveyor 16.

With continued reference to FIGS. 5-7, the second sensor 46 may be positioned on the loading side of the carton conveyor 16 so as to face the loading end 76 of each carton 28. In that regard, the second sensor 46 may be configured to detect the presence of a flap 80, 82, 84 at the loading end 76 of each carton 28, such as the top flap 80. Specifically, the second sensor 46 may detect for the correct upward orientation of the top flap 80 at the loading end 76 of each carton 28, indicating that the carton 28 is oriented in an open configuration with the flaps 80, 82, 84 clear leaving the loading end 76 open to receive product 38. The third sensor 48 may be positioned on the opposite side of the carton conveyor 16 from the second sensor 46. The third sensor 48 may be oriented to face upward and, as a result, may be arranged lower relative to the conveying surface of the carton conveyor 16. The third sensor 48 may also be configured to detect the presence of a flap 80, 82, 84 on each carton 28, such as the bottom flap 82 at the second end 78 of the carton 28. Specifically, the third sensor 48 may detect the correct planar orientation of the bottom flap 82, indicating that the bottom panel 72 of the carton 28 is properly oriented, confirming an opened configuration of the carton 28. As each carton 28 is conveyed past the carton detection system 42, each of the sensors 44, 46, 48 is operable to detect aspects of the carton 28, as described above, to confirm that the carton 28 is in the opened configuration. To that end, confirmation from all three sensors 44, 46, 48 that the detected panel 70, 72, 74 or flap 80, 82, 84 of each carton 28 is present, and/or correctly oriented, may be required in order to receive verification that the carton 28 is in the correct, open configuration. To that end, if any one of the sensors 44, 46, 48 indicates a failure, being that the panel 70, 72, 74 or flap 80, 82, 84 of each carton 28 is not present, and/or incorrectly oriented, the carton 28 is identified as a malformed carton 88.

As shown in FIG. 7, the carton feeder 14 has produced an L-shaped malformed carton 88. The malformed carton 88 is conveyed along the carton conveyor 16 to the carton detection system 42, where the three sensors 44, 46, 48 detect for the presence and/or the correct orientation of the panel(s) 70, 72, 74 and/or flap(s) 80, 82, 84 of the malformed carton 88. In that regard, the first sensor 44 may detect for the top panel 70 of the malformed carton 88. The first sensor 44 will detect the top panel 70 and therefore indicate a positive detection that the malformed carton 88 is properly erected and opened. However, as shown, the top flap 80 at the loading end 76 of the malformed carton 88 is not in the correct upward orientation and will therefore not be detected by the second sensor 44. As a result, the second sensor 44 will register an incorrect orientation or absence of the top flap 80, flagging or detecting the malformed carton 88. Similarly, as the bottom panel 72 of the malformed carton 88 did not unfold (e.g., FIG. 4), the bottom flap 82 of the malformed carton will not be in the correct position. As a result, the third sensor 48 will register an incorrect orientation or absence of the bottom flap 82, again flagging or detecting the malformed carton 88.

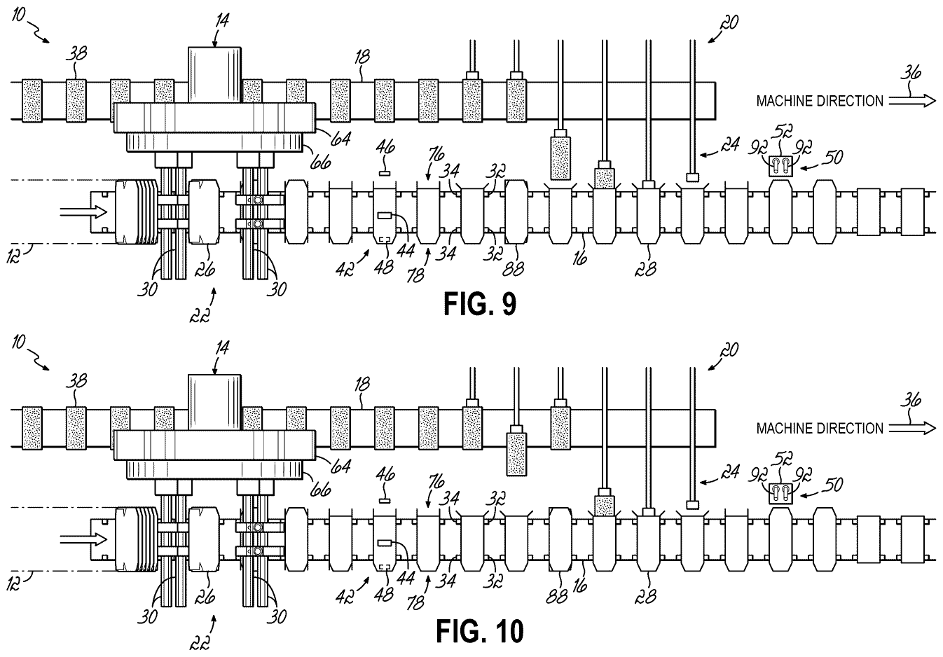

Turning now with reference to FIGS. 8 and 9, once a malformed carton 88 has been identified or confirmed by the carton detection system 42, the positioning of the malformed carton 88 on the carton conveyor 16 may be flagged for tracking by the system 10 so that product 38 may not be loaded into the malformed carton 88. In that regard, the malformed carton 88 continues to be conveyed in the carton feed direction by the carton conveyor 16 to the product loading station 24. As shown in FIG. 10, upon reaching the product loading station 24, rather than being loaded with product 38, the product inserter 20 bypasses the malformed carton 88 by not loading or attempting to load product 38 into the malformed carton 88. That is, the product inserter 20 skips the malformed carton 88. In an alternative embodiment, the carton reject system 50 may be positioned upstream of the product inserter 20 and the product loading station 24 to reject and remove each malformed carton 88 before it reaches the product inserter 20, as shown in FIG. 1A. The product inserter 20 then skips the empty space on the carton conveyor 12 where the malformed carton 88 was located.

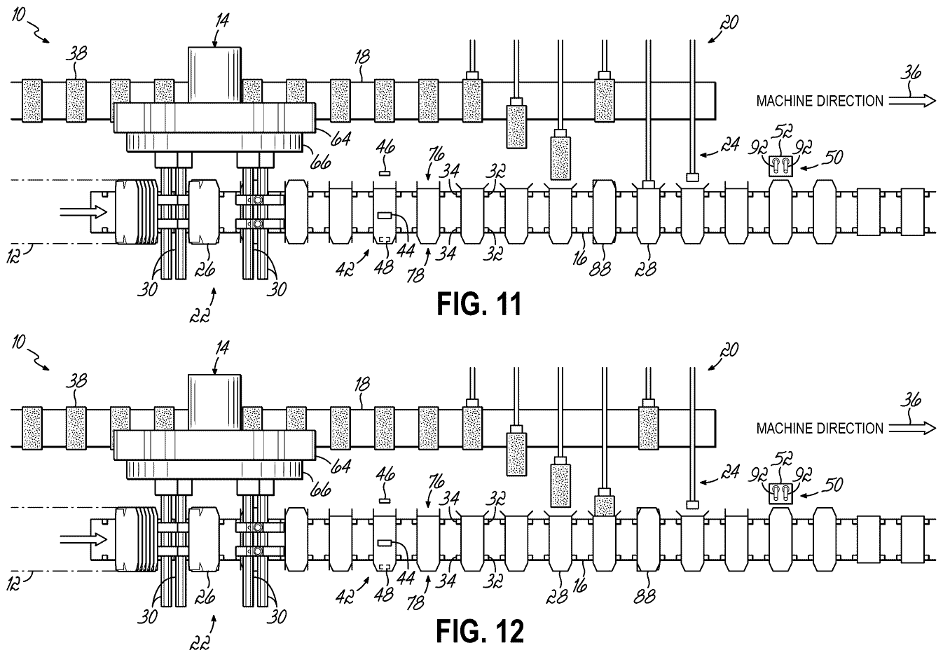

Referring now to FIGS. 11-14, the malformed carton 88 is conveyed in the carton feed direction 36 by the carton conveyor 16, along with the cartons 28 that have been filled with product 38, away from the product loading station 24, and past the carton reject system 50. As shown in FIG. 14, product 38 that was intended for each malformed carton 88 is carried downstream by the product conveyor 18 to a diversion station 90, where the product 38 may be discarded or redirected for recycling or reprocessing. The diversion station 90 may include an actuator that removes the diverted product 38 from the product conveyor 18, directing the diverted product 38 to a designated location for further processing or discarding.

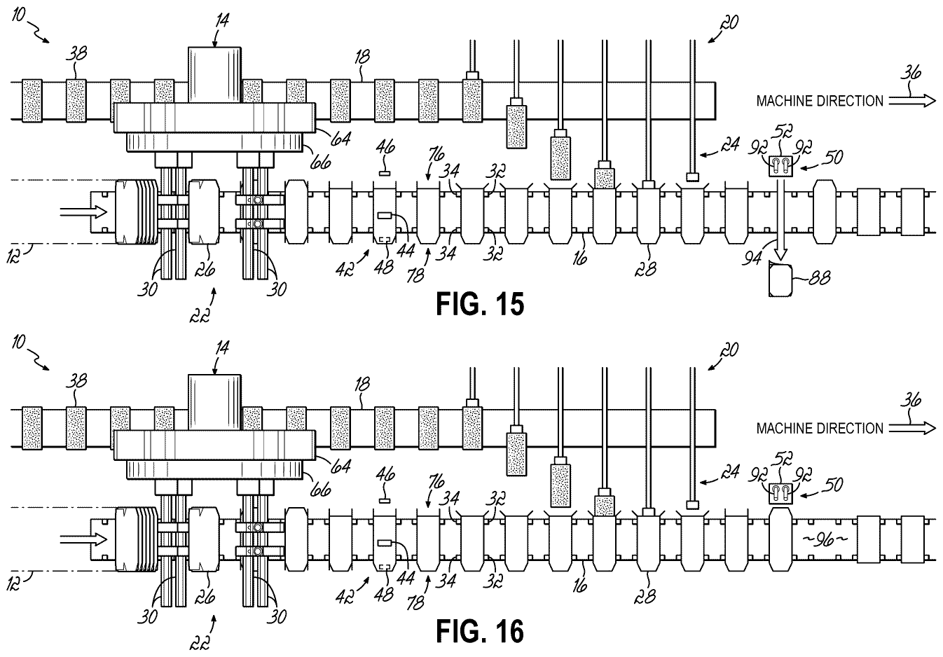

In the embodiment of the cartoning system 10 shown, the carton reject system 50 includes at least one blow-off device 52 that is configured to contactlessly remove each malformed carton 88 from the carton conveyor 16. The blow-off device 52 may be located off to one side of the carton conveyor 16, beneath the carton conveyor 16, or above the carton conveyor 16, for example. Regardless, the blow-off device 52 is configured to selectively discharge a controlled volume of gas aimed at the conveying surface of the carton conveyor 16, and in particular each malformed carton 88 conveyed therealong, to remove the malformed carton 88 from the carton conveyor 16. To that end, the blow-off device 52 may be connected to a compressed air source and include one or more nozzles 92 that are controllable to selectively direct a blast of compressed air at the malformed carton 88 as it passes by the carton reject system 50 to blow or knock the malformed carton 88 off of the carton conveyor 16 and into a discard area of the cartoning system 10, as shown in FIG. 15. The nozzles 92 may be angled to direct the air blast generally perpendicular to the machine direction 36, ensuring that each malformed carton 88 is removed in a consistent direction, as indicated by directional arrow 94. That way, each malformed carton 88 removed by the carton reject system 50 lands reliably in a designated discard area adjacent to the carton conveyor 16.

As shown in FIG. 16, the carton conveyor 16 continues to transport cartons 28 at the desired operational speed without slowing, pausing, or requiring manual intervention to remove each malformed carton 88 from the workflow. In that regard, the carton reject system 50 operates independently of other components of the cartoning system 10, such as the carton feeder 14, to remove the malformed carton 88 without slowing, pausing, or stopping operation of the system 10. Each malformed carton 88, once detected, is automatically removed by the carton reject system 50 without reworking or further processing of the malformed carton 88 before removal. After removal, only a void or empty space 96 remains on the carton conveyor 16 where the malformed carton 88 was previously positioned.

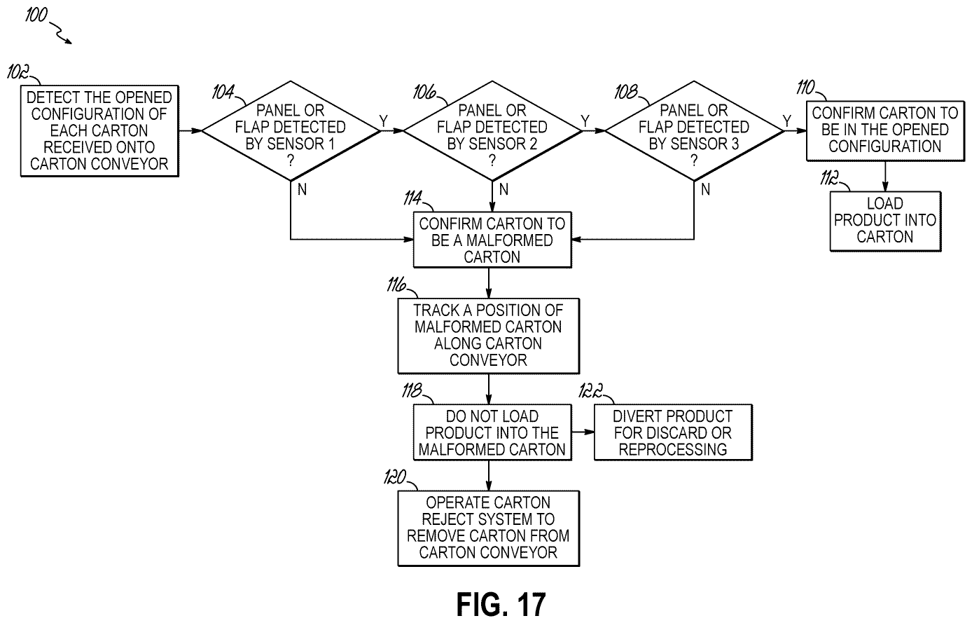

FIG. 17 depicts a flowchart illustrating a process 100 for detecting and removing a malformed carton 88 from the cartoning system 10 that may be implemented by the computer 54. For example, the process 100 may be exemplary of the process described above with respect to FIGS. 7-16. In block 102, the malformed carton detection system 42 detects for the opened configuration of each carton 28 received onto the carton conveyor 16. In that regard, each of the sensors 44, 46, 48 of the malformed carton detection system 42 detect for a proper orientation of a panel 70, 72, 74 or flap 80, 82, 84 of each carton 28. In particular, in block 104, the first sensor 44 (sensor 1) detects for the presence and/or an orientation of a panel 70, 72, 74 or flap 80, 82, 84 of each carton 28. If a correct orientation of the panel 70, 72, 74 or flap 80, 82, 84 of the carton 28 is detected, the opened configuration of the carton 28 is confirmed and the process 100 proceeds to block 106. In block 106, the second sensor 46 (sensor 2) of the malformed carton detection system 42 detects for the presence and/or an orientation of a panel 70, 72, 74 or flap 80, 82, 84 of each carton 28. If a correct orientation of the panel 70, 72, 74 or flap 80, 82, 84 of the carton 28 is detected by the second sensor 46, the opened configuration of the carton 28 is again confirmed and the process 100 proceeds to block 108. In block 108, the third sensor 48 (sensor 3) of the malformed carton detection system 42 detects for the presence and/or an orientation of a panel 70, 72, 74 or flap 80, 82, 84 of each carton 28. If a correct orientation of the panel 70, 72, 74 or flap 80, 82, 84 of the carton 28 is detected by the third sensor 48, the opened configuration of the carton is again confirmed and the process 100 proceeds to block 110.

If all three sensors 44, 46, 48 confirm the opened configuration of the carton 28, the process 100 confirms the carton 28 to be in the opened configuration, per block 110. Product 38 is loaded into each carton 28 that is confirmed to be in the opened configuration, per block 112. However, if any one of the three sensors 44, 46, 48 detects an incorrect orientation of the panel 70, 72, 74 or flap 80, 82, 84 of one carton 28, the process 100 confirms the carton 28 to be a malformed carton 88, per block 114. In block 116, the process 100 may track a position of the malformed carton 88 along the carton conveyor 16. For example, the carton slot between a set of lugs 32, 34 on the carton conveyor 16 may be flagged for tracking of the malformed carton 88 by the process 100. In block 118, product 38 is not loaded into the malformed carton 88. That is, the process 100 bypasses the loading of product 38 into the malformed carton 88. The process 100 then proceeds to block 120 where the carton reject system 50 is operated to remove the malformed carton 88 from the carton conveyor 16. From block 118, the process 100 may also proceed to block 122, where the product 38 intended for the malformed carton 88 is diverted for discard or reprocessing.

While the invention has been illustrated by the description of various embodiments thereof, and while the embodiments have been described in considerable detail, it is not intended to restrict or in any way limit the scope of the appended claims to such detail. Thus, the various features discussed herein may be used alone or in any combination. Additional advantages and modifications will readily appear to those skilled in the art. The invention in its broader aspects is therefore not limited to the specific details and illustrative examples shown and described. Accordingly, departures may be made from such details without departing from the scope of the general inventive concept.

1. A method of packaging product in cartons, the method comprising:
providing a cartoning system including a carton magazine including a plurality of carton blanks, a carton feeder, a carton conveyor, a product conveyor, a product inserter, a carton detection system, and a carton reject system;
operating the carton feeder to transfer carton blanks to the carton conveyor;
conveying each carton along the carton conveyor in a carton feed direction;
conveying product along the product conveyor in a product feed direction;
detecting an opened configuration of each carton with the carton detection system;
loading product into each carton that is detected to be in the opened configuration;
detecting a malformed carton with the carton detection system;
operating the carton conveyor to continuously convey cartons in the carton feed direction without interruption upon detection of one or more malformed cartons; and
operating the carton reject system to remove the malformed carton from the carton conveyor while continuing to operate the carton conveyor to convey cartons in the carton feed direction.

2. The method of claim 1, wherein each malformed carton is removed from the carton conveyor without additional processing of the malformed carton prior to removal.

3. The method of claim 1, wherein each malformed carton is removed from the carton conveyor in the malformed configuration.

4. The method of claim 1, wherein the carton reject system contactlessly removes each malformed carton from the carton conveyor.

5. The method of claim 4, wherein the carton reject system includes a blow-off device configured to selectively discharge a controlled volume of gas, the method further comprising:
operating the blow-off device to release the controlled volume of gas aimed at the malformed carton to remove the malformed carton from the carton conveyor.

6. The method of claim 1, wherein the carton reject system is located downstream of the product inserter in the cartoning system.

7. The method of claim 1, wherein the carton reject system is located upstream of the product inserter in the cartoning system.

8. The method of claim 6, further comprising:
bypassing the malformed carton by not loading product into the malformed carton.

9. The method of claim 1, further comprising:
operating the product conveyor to continuously convey product in the product feed direction without interruption upon detection of one or more malformed cartons.

10. The method of claim 1, wherein the carton detection system includes at least one sensor that is configured to detect a panel or a flap of each carton, wherein for each carton:
if a correct orientation of the panel or the flap of the carton is detected, confirming the opened configuration of the carton; or
if an incorrect orientation of the panel or the flap of the carton is detected, confirming the carton to be the malformed carton for removal.

11. The method of claim 10, wherein the at least one sensor of the carton detection system includes a first sensor configured to detect an orientation of a panel of each carton, a second sensor configured to detect an orientation of a first end flap at a first end of each carton, and a third sensor configured to detect an orientation of a second end flap at an opposite second end of each carton, wherein an incorrect orientation detected by any one of the first sensor, the second sensor, or the third sensor results in confirming the carton to be the malformed carton for removal.

12. The method of claim 1, wherein the carton feeder is configured to reconfigure each carton blank from a collapsed configuration to the opened configuration to define each carton that is configured to receive product.

13. A cartoning system for packaging product in cartons, comprising:
a carton magazine including a plurality of carton blanks;
a carton feeder that is configured to transfer carton blanks to a carton conveyor in a carton feed direction;
a carton detection system that is configured to detect an opened configuration of each carton or a malformed carton, wherein the carton conveyor is configured to continuously convey cartons in the carton feed direction without interruption upon detection of one or more malformed cartons by the carton detection system;
a carton reject system that is configured to remove each malformed carton from the carton conveyor; and
a computer operatively coupled to the cartoning system, the computer being configured to operate the cartoning system as follows:
operate the conveyor to convey each carton along the carton conveyor in a carton feed direction;
operate the carton detection system to detect for the opened configuration of each carton or if the carton is malformed;
if the carton is detected to be malformed, operate the carton reject system to remove the malformed carton from the carton conveyor while continuing to operate the carton conveyor to convey cartons in the carton feed direction.

14. The cartoning system of claim 13, further comprising a product inserter, and the carton reject system is located downstream of the product inserter.

15. The cartoning system of claim 13, further comprising a product inserter, and the carton reject system is located upstream of the product inserter.

16. The cartoning system of claim 13, wherein the carton reject system is configured to contactlessly remove the malformed carton from the carton conveyor.

17. The cartoning system of claim 13, wherein the carton reject system includes a blow-off device that is configured to selectively discharge a controlled volume of gas aimed at the malformed carton to remove the malformed carton from the carton conveyor.

18. The cartoning system of claim 13, wherein the carton feeder is configured to reconfigure each carton blank from a collapsed configuration to the opened configuration to define each carton that is configured to receive product.

19. The cartoning system of claim 13, wherein the carton detection system includes at least one sensor that is configured to detect a panel or a flap of each carton, the controller being configured to operate the cartoning system as follows:
if a correct orientation of the panel or the flap of the carton is detected, confirming the opened configuration of the carton; or
if an incorrect orientation of the panel or the flap of the carton is detected, confirming the carton to be the malformed carton for removal.

20. The cartoning system of claim 19, wherein the at least one sensor of the carton detection system includes a first sensor configured to detect an orientation of a panel of each carton, a second sensor configured to detect an orientation of a first end flap at a first end of each carton, and a third sensor configured to detect an orientation of a second end flap at an opposite second end of each carton, wherein an incorrect orientation detected by any one of the first sensor, the second sensor, or the third sensor results in confirming the carton to be the malformed carton for removal.

21. The cartoning system of claim 13, wherein the carton reject system operates independently of the carton feeder to remove the malformed carton.
